(19) United States
(12) Patent Application Publication
(10) Pub. No.: US 2008/0206601 A1
(43) Pub. Date: Aug. 28, 2008

(54) PERPENDICULAR MAGNETIC RECORDING MEDIUM AND METHOD OF MANUFACTURING THE SAME

(75) Inventor: Ryoichi Mukai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/028,518

(22) Filed: Feb. 8, 2008

(30) Foreign Application Priority Data
Feb. 26, 2007 (JP) 2007-045546

(51) Int. Cl. G11B 5/62; B05D 5/12

(52) U.S. Cl. 428/831; 427/131

(57) ABSTRACT

A perpendicular magnetic recording medium includes a substrate, a first underlayer formed over the substrate and formed of ruthenium or a ruthenium alloy with crystal grains growing approximately perpendicular to the substrate and isolated from one another in an in-plane direction by a first air gap, a recording layer placed over the first underlayer and formed of magnetic crystal grains growing approximately perpendicular to the substrate and isolated one another in the in-plane direction by a second air gap, and a grain size dispersion preventing layer inserted between the recording layer and the first underlayer, the grain size dispersion preventing layer including crystal grains of a cobalt-based alloy growing approximately perpendicular to the substrate and an oxide isolating the crystal grains of the cobalt-based alloy from one another in the in-plane direction.

### BACKGROUND OF THE INVENTION

1. Field of the Invention

The present invention relates generally to a magnetic recording medium and a method of manufacturing the same, and more particularly to improvement of a perpendicular magnetic recording medium having a magnetic layer composed of magnetic crystal grains spatially isolated from one another in a plane parallel to the recording surface.

2. Description of the Related Art

A hard disk drive is a large-capacity digital data storage device with a low cost per bit of the storage, and accordingly, its use has been widely spread in recent years, including typical applications to personal computers. Being in a ubiquitous age, it is expected that demand for the hard disk drive serving as a storage device will be further increasing, driven by increased applications to audio and visual digital recording equipment. To record or store video data or audio data, it is required to further increase the storage capacity of the hard drive disk.

Since the target market of audio and visual recording and reproducing apparatuses is home consumer market, the memory cost per bit has to be further reduced in increasing the memory capacity. To reduce the cost per bit of the storage device, it is effective to reduce the number of components constituting the hard disk drive. For instance, by increasing the recording density of each of the magnetic recording media (e.g., the magnetic disks), the recording capacity can be increased without increasing the number of magnetic recording media used in the hard disk drive. If super high-density recording is realized, the number of magnetic recording media may be reduced, while increasing the total recording capacity, which can further reduce the number of magnetic heads used in the hard disk drive. If this is achieved, the cost per bit of the storage can significantly reduced.

In these circumstances, increase of the recording density of a magnetic recording medium is a proposition, and achieving a high SN (signal to noise) ratio by increasing the resolution (output level) while reducing noise is a major challenge. To realize this, it is necessary to reduce the grain size of the magnetic crystal grains of a magnetic recording layer and to secure magnetic isolation of the magnetic crystal grains.

In fabrication of perpendicular magnetic recording media, a cobalt-chromium (CoCr) based alloy is conventionally used in the magnetic recording layer. In this case, the CoCr-based alloy layer is formed by sputtering while applying heat to the substrate so as to segregate non-magnetic chromium (Cr) at the grain boundaries of the magnetic crystal grains of the CoCr-based alloy. The segregated non-magnetic chromium magnetically isolates the magnetic crystal grains. However, it is necessary for the perpendicular magnetic recording medium to insert a soft magnetic amorphous layer as an underlayer in order to reduce spike noise arising from formation of magnetic domains. To maintain the soft magnetic layer amorphous, the heating process applied to the substrate for segregation of chromium when forming the recording layer has to be withheld.

To overcome this issue, a new type of recording layer formed of CoCr-based alloy with SiO2 isolation has been developed in place of chromium (Cr) segregation that requires a heating process during fabrication of a perpendicular recording medium. In this technique, the magnetic crystal grains of the CoCr-based alloy (such as CoCrPt) are spatially separated from one another by non-magnetic SiO2 to secure magnetic isolation.

It is proposed to structure a ruthenium (Ru) underlayer inserted under the recording layer such that ruthenium crystal grains are spatially separated from one another by air gaps, in order to secure the magnetic isolation of magnetic crystal grains of the recording layer in which each of the magnetic crystal grains is surrounded by a non-magnetic material such as SiO2. See, for example, JP 2005-353256A.

It is more preferable that the magnetic crystal grains of the recording layer be spatially separated from one another without using a non-magnetic material such as an oxide, so that contamination in the deposition chamber or on the substrate can be reduced and the reliability of the product can be improved. In addition, it is desired to reduce the dispersion or variation in the grain size of the recording layer, while maintaining special isolation of magnetic crystal grains in the in-plane direction.

### SUMMARY OF THE INVENTION

In one aspect of an embodiment, a perpendicular magnetic recording medium includes:

a substrate;

a first underlayer formed over the substrate and formed of ruthenium or a ruthenium alloy with crystal grains growing perpendicular to the substrate and isolated from one another in an in-plane direction by a first air gap;

a recording layer placed over the first underlayer and formed of magnetic crystal grains growing perpendicular to the substrate and isolated from one another in the in-plane direction by a second air gap; and

a grain size dispersion preventing layer inserted between the recording layer and the first underlayer, the grain size dispersion preventing layer including crystal grains of a cobalt-based alloy growing perpendicular to the substrate and an oxide isolating the crystal grains of the cobalt-based alloy from one another in the in-plane direction.

In another aspect of an embodiment, a method of manufacturing a perpendicular recording medium is provided. The method includes:

forming a first underlayer of ruthenium (Ru) or ruthenium (Ru) alloy with crystal grains isolated from one another by a first air gap;

forming a grain size dispersion preventing layer over the first underlayer, the grain size dispersion preventing layer including crystal grains of a cobalt-based alloy spatially isolated from one another by an oxide; and

forming a recording layer directly on the grain size dispersion preventing layer, the recording layer including magnetic crystal grains isolated from one another by a second air gap.

### BRIEF DESCRIPTION OF THE DRAWINGS

Other objects, features and advantages of the present invention will become more apparent from the following detailed description when read in conjunction with the accompanying drawings, in which:

FIG. 1 is a schematic cross-sectional view of a perpendicular magnetic recording medium proposed in the course of development of the present invention;

FIG. 2 is a schematic cross-sectional view of a perpendicular magnetic recording medium according to an embodiment of the invention;

FIG. 3A is a TEM image of the magnetic crystal grains of the recording layer of the perpendicular magnetic recording medium according to an embodiment of the invention;

FIG. 3B is a graph showing the dispersion (or the variance) in the grain size of the recording layer shown in FIG. 3A:

FIG. 4A is a TEM image of the magnetic crystal grains of the recording layer of the perpendicular magnetic recording medium shown in the comparison structure shown in FIG. 1;

FIG. 4B is a graph showing the dispersion (or the variance) in the grain size of the recording layer of the comparison structure of FIG. 4A;

FIG. 5A is a TEM image of the magnetic crystal grains of the recording layer with a different film thickness according to an embodiment of the invention;

FIG. 5B is a graph showing the dispersion (or the variance) in the grain size of the recording layer shown in FIG. 5A; and

FIG. 6 is a plan view illustrating the major part of a magnetic storage apparatus according to an embodiment of the invention.

### DETAILED DESCRIPTION OF THE PREFERRED EMBODIMENTS

The preferred embodiments of the invention are described below in more detail in conjunction with the attached drawings.

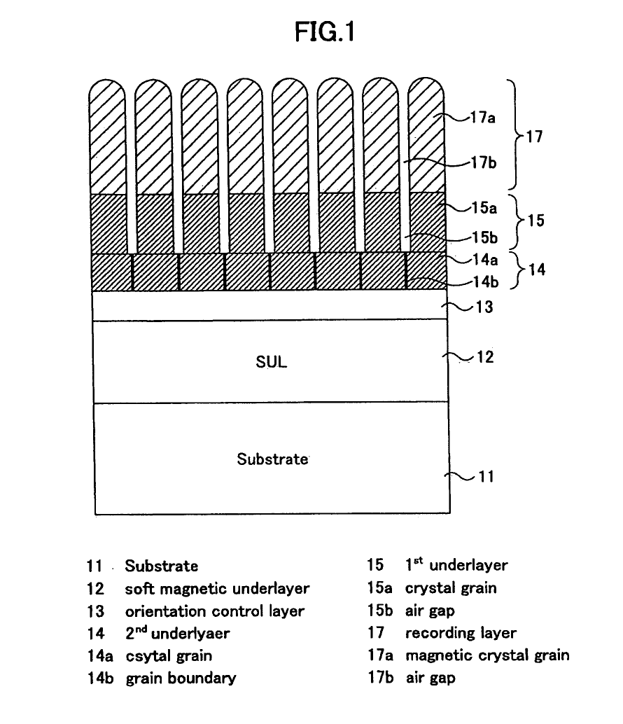

FIG. 1 is a schematic cross-sectional view of a perpendicular magnetic recording medium proposed in the course of the development of the present invention. The reliability of manufacture is improved by reducing contamination in the deposition chamber or on the substrate surface. To achieve this, it is proposed to grow magnetic crystal grains 17a approximately perpendicular to the substrate and in alignment with the first underlayer 15 with crystal grains 15 isolated from one another by air gaps 15b, without using a non-magnetic material in the recording layer 17. With this method, magnetic crystal grains 17a of the recording layer 17 are spatially separated from one another in plane by air gaps 17b. In this structure, a soft magnetic underlayer 12 and an orientation control layer 13 are provided over the substrate 11 in this order. The second underlayer 14 and the first underlayer 15 are provided over the orientation control layer 13 in this order. The first and second underlayers are made of the same material, for example, ruthenium (Ru). The second underlayer 14 is not indispensable, and it may be omitted. However, by inserting the second underlayer 14 directly beneath the first underlayer 15, the crystallographic property and the crystal orientation of the first underlayer 15 is improved. This arrangement can further improve the crystallographic property and the crystal orientation of the magnetic crystal grains 17a formed over the first underlayer 15.

However, in the recording layer 17 with the magnetic crystal grains 17a spatially separated from one another by the air gaps 17b in the in-plane direction, the dispersion or the variance in the grain size increases. It is considered that some magnetic crystal grains are combined with each other at a local site as they grow. In this case, high recording density may not be sufficiently achieved.

To overcome the problem, an embodiment of the invention provides a grain size dispersion preventing layer inserted directly beneath the magnetic layer serving as the recording layer. The grain size dispersion preventing layer includes crystal grains of a cobalt-based alloy separated from one another by an oxide. For this reason, the grain size dispersion preventing layer may be named an “oxide-added cobalt-based alloy crystal grain layer”. Immediately under the grain size dispersion preventing layer is provided the first underlayer with ruthenium (Ru) grains isolated from one another in plane by the air gaps 15b.

With this arrangement, dispersion or variance in grain size of the spatially isolated magnetic crystal grains of the recording layer can be reduced, while the average grain size can be maintained small. Consequently, the recording density of the magnetic recording medium can be improved.

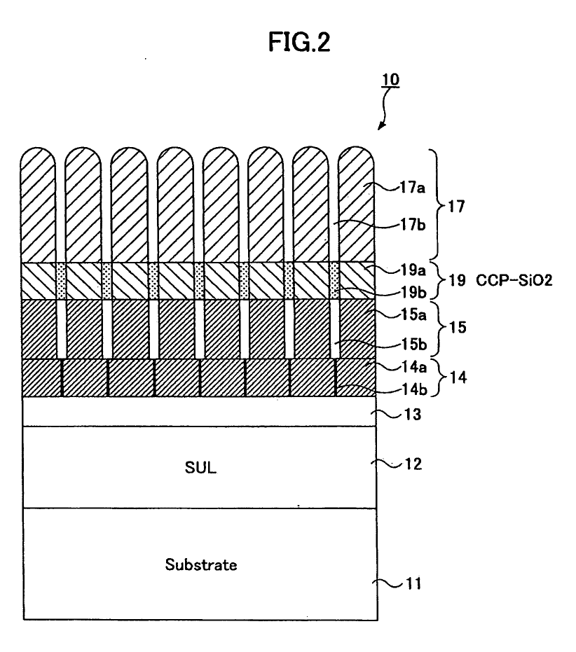

FIG. 2 is a schematic cross-sectional view of a perpendicular magnetic recording medium 10 according to an embodiment of the invention. The perpendicular magnetic recording medium 10 includes a soft magnetic underlayer 12, an orientation control layer 13, a second underlayer 14, a first underlayer 15, a grain size dispersion preventing layer (oxide-added Co-based alloy crystal grain layer) 19, and a recording layer 17 deposited in this order over the substrate 11.

The substrate 11 is an arbitrary substrate suitably used in a magnetic recoding medium; examples of the substrate 11 include a plastic substrate, a crystallized glass substrate, a silicon (Si) substrate, a ceramic substrate, and a heat resistant resin substrate. In the embodiment, a crystallized glass substrate is used.

The soft magnetic underlayer (SUL) 12 is formed of an arbitrary amorphous or microcrystalline soft magnetic material, and the thickness ranges from 50 nm to 2 μm. The soft magnetic underlayer 12 may be formed as a single layer or multiple layers. From the viewpoint of efficient concentration of the recording magnetic field, a soft magnetic material with the saturated flux density at or above 1.0 T is desired. Examples of such a soft magnetic material include FeSi, FeAlSi, FeTaC, CoNbZr, CoCrNb, NiFeNb, and Co.

The orientation control layer 13 has a film thickness ranging from 2.0 nm to 10 nm, and serves to orient the c-axes of the crystal grains of the first and second underlayers 14 and 15, which are to be formed over the orientation control layer 13, in the direction of film thickness. The orientation control layer 13 also serves to uniformly disperse the crystal grains of the underlayers 14 and 15 in the in-plane direction. The orientation control layer 13 is formed of at least one selected from the group of Ta, Ti, C, Mo, W, Re, Os, Hf, Mg, Pt, and an alloy thereof. Alternatively, the orientation control layer 13 may be formed of an amorphous metal, such as NiP.

The second underlayer 14 is a continuous polycrystalline layer formed of ruthenium (Ru) or a Ru alloy having an hcp (hexagonal close-packed) crystal structure, and includes crystal grains 14a and grain boundaries 14b. Because the second underlayer 14 is a continuous polycrystalline layer in which crystal grains 14a are bound to each other via the grain boundaries 14b, it has superior crystallographic properties with the (0001) facet oriented approximately perpendicular to the substrate 11. The second underlayer 14 is not indispensable, and it may be omitted. However, it is desired to insert the second underlayer 14 immediately beneath the first underlayer 15 in terms of improving the crystallographic properties and the crystal orientation of the first underlayer 15 and the recording layer 17.

The first underlayer 15 is positioned immediately on the second underlayer 14, and includes crystal grains 15a growing approximately perpendicular to the substrate 11, and air gaps 15b isolating the crystal grains 15a from one another in the in-plane direction. This structure is realized by controlling the crystal growth conditions, which is described in more detail below.

Over the first underlayer 15 with crystal grains 15a isolated from one another by air gaps 15b is provided a grain size dispersion preventing layer 19. The grain size dispersion preventing layer 19 is structured by cobalt (Co) based alloy crystal grains 19a which are in alignment with the crystal grains 15a of the first underlayer 15, and an oxide 19b filling the spaces between the Co-based alloy crystal grains 19a. The film thickness of the grain size dispersion preventing layer (i.e., the oxide-added Co-based alloy crystal grain layer) is about 5 nm to 12 nm.

A recording layer 17 is positioned over the grain size dispersion preventing layer 19. The recording layer 17 does not comprise oxide, instead, it comprises magnetic crystal grains 17a growing approximately perpendicular to the substrate 11, and air gaps 17b separating the magnetic crystal grains 17a from one another in the in-plane direction. The magnetic crystal grains 17a are formed of a ferromagnetic material with the hcp crystal structure, which material may be a cobalt based alloy such as CoCr, CoCrTa, CoPt, CoCrPt, or CoCrPt-M.

By inserting the grain size dispersion preventing layer 19 immediately beneath the recording layer 17, the in-plane variation in the grain size of the magnetic crystal grains 17a is effective reduced. It is considered that because the spatial isolation of the crystal grains 19a of the Co-based alloy can be secured by the oxide 19b in the grain size dispersion preventing layer 19, the magnetic crystal grains 17a of the recording layer 19 formed immediately on the grain size dispersion preventing layer 19 can grow approximately perpendicular to the substrate with the air gaps 19b separating them in a reliable manner. In addition, the crystallographic property and the crystal orientation of the magnetic crystal grains 17a are maintained in a satisfactory state because of the existence of the first underlayer 15 provided immediately beneath the grain size dispersion preventing layer 19.

The perpendicular magnetic recording medium 10 is covered with a protection layer (not shown), and a lubricating layer (not shown) may be further provided over the protection layer as necessary.

In a fabrication process of the perpendicular magnetic recording medium 10, after the surface of the substrate 11 is cleaned and dried, a CoNbZr layer with a thickness of 200 nm is formed as the the soft magnetic underlayer 12 over the substrate 11. Then, a tantalum (Ta) layer with a thickness of 3 nm is formed as the orientation control layer 13 over the CoNbZr soft magnetic underlayer 12. The CoNbZr soft magnetic underlayer 12 and the Ta (orientation control) layer 13 are formed by a DC sputtering method at room temperature in an argon (Ar) gas atmosphere at a pressure of 3 millitorr (about 0.4 Pa).

Then, a ruthenium (Ru) continuous polycrystalline layer with a thickness of 9 nm is formed as the second underlayer 14 over the orientation control layer 13. The growth conditions of the Ru continuous polycrystalline layer 14 are DC sputtering at room temperature in the Ar gas atmosphere at a pressure of 1 millitorr (0.133 Pa), with the deposition rate of 0.6 nm/s in this example. The Ru continuous polycrystalline layer, which serves as the second underlayer 14, can be formed at an Ar gas pressure at or below 10 millitorr (1.33 Pa) and/or at a deposition rate at or above 0.5 nm/s.

Then, a ruthenium (Ru) layer with a thickness of 10 nm is formed as the first underlayer 15 over the second underlayer 14. The growth conditions are DC sputtering at a room temperature at a deposition rate of 0.3 nm/s at an Ar gas pressure of 40 millitorr (5.33 Pa). Under these conditions, the first underlayer 15 with Ru crystal grains 15a isolated from one another in plane by the air gaps 15b can be formed. This film structure of the first underlayer (with the Ru crystal grains 15a isolated from one another by the air gaps 15b) can be formed under the conditions at an Ar gas pressure at or above 20 millitorr (2.66 Pa) and a deposition rate at or below 2 nm/s.

Then, an oxide-added Co-based alloy crystal grain layer with a thickness of 6.6 nm is formed as the grain size dispersion preventing layer 19 over the first underlayer 15 by a sputtering method at an Ar gas pressure of 40 millitorr (5.33 Pa) and a deposition rate of 0.2 nm/s. In this example, CoCrPt is used as the Co-based alloy, and SiO2 is used as the oxide which isolates the crystal grains of CoCrPt from one another (to structure a CCP—SiO2 layer). In the sputtering, a composite target of a combination of the CoCrPt material and the SiO2 material may be used, or alternatively, simultaneous sputtering may be performed using separate targets. The structure of the oxide-added Co-based alloy crystal grain layer can be formed under the conditions of an Ar gas pressure at or above 20 millitorr (3.66 Pa) and a deposition rate at or below 2 nm/s.

Over the grain size dispersion preventing layer 19 is formed a Co₈₀Pt₂₀ magnetic layer with a thickness of 10 nm, which serves as the recording layer 17. The growth conditions are DC sputtering at room temperature at an Ar gas pressure of 40 millitorr (5.33 Pa) and a deposition rate of 0.2 nm/s. The Co₆₀Pt₂₀ magnetic crystal grains 17a can grow approximately perpendicular to the substrate 11 so as to be isolated from one another by the air gaps 17b at a deposition rate at or below 0.3 nm/s.

To increase the recording density of a magnetic recording medium, it is generally necessary to reduce the grain size of the magnetic crystal grains; however, the resistance to thermal disturbance is degraded as the grain size is reduced. To overcome this problem, it is desired to use a magnetic material with a high Ku value (crystal magnetic anisotropy). It is known that a cobalt (Co) alloy with an increased amount of platinum (Pt) has a relatively high Ku value. Since a platinum-rich cobalt alloy does not require a high-temperature process, unlike a regularized alloy, it is suitably used together with an amorphous soft magnetic underlayer 12 when fabricating a recording medium. As a matter of course, other suitable Co-based alloys may be used in place of the platinum-rich cobalt alloy.

By inserting the grain size dispersion layer 19 with the CoCrPt crystal grains 19a isolated by the oxide (SiO2) 19b between the recording layer having the air gaps 17b and the first underlayer 15 having the air gaps 15b, the in-plane variation in the grain size of the recording layer 17 can be satisfactorily reduced.

Then, a carbon layer with a thickness of 3 nm is formed as the protection film 16 over the recording layer 17. Throughout the above-described fabrication process of the perpendicular magnetic recording medium 10, the vacuum environment is maintained and each of the sputtering steps is carried out at room temperature without applying heat to the substrate 11.

Although, in the above-described example, DC sputtering is employed to form the soft magnetic underlayer (CoNbZr layer) 12, the orientation control layer (Ta layer) 13, the first and second underlayers (Ru layers) 15 and 14, and the recording layer (Co₈₀Pt₂₀ layer) 17, any suitable deposition method such as RF sputtering or vacuum vapor deposition may be employed. For the first and second underlayers 15 and 14, Ru—X alloy (X is at least one selected from Co, Cr, Fe, Ni, and Mn) may be used in place of ruthenium.

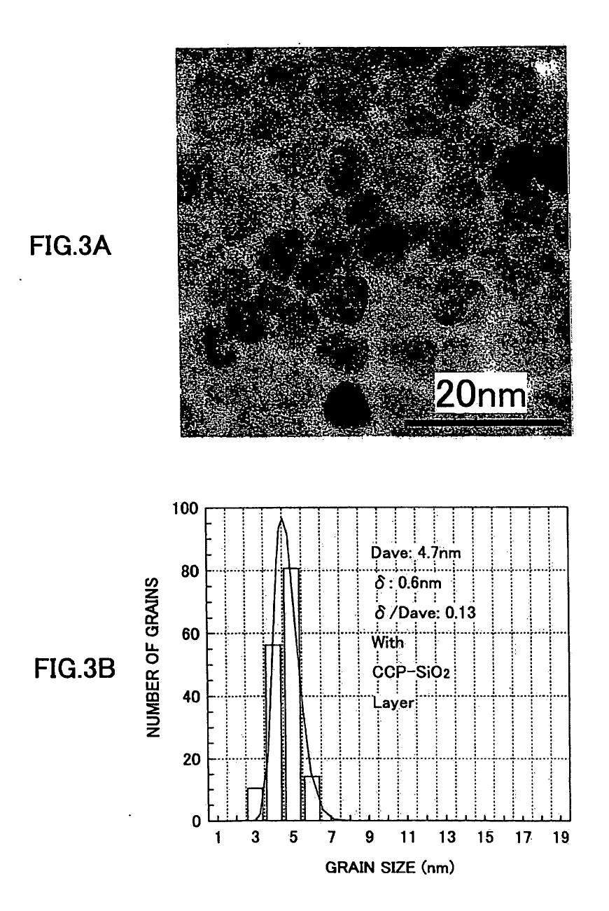

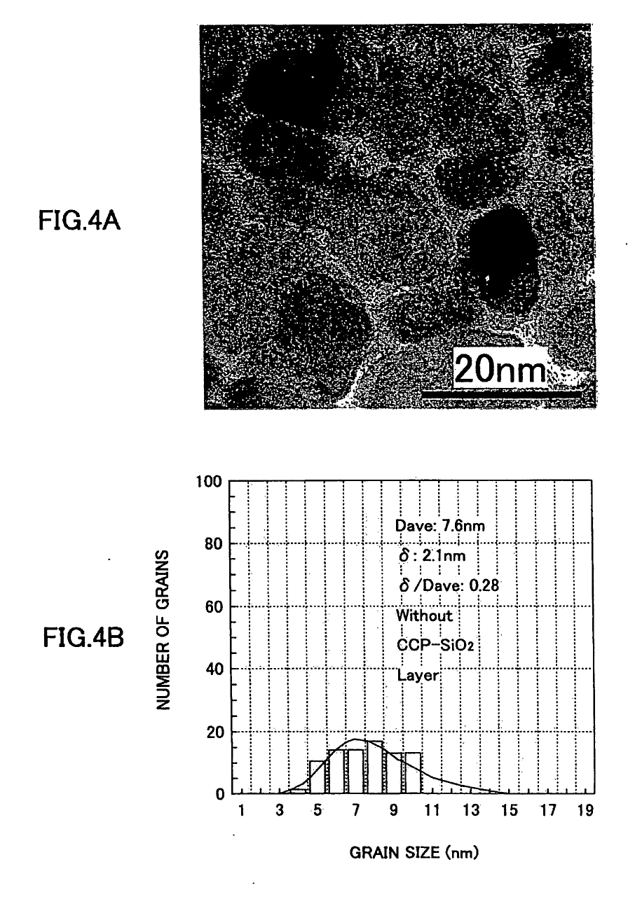

FIG. 3A is a plan-view TEM image of the recording layer with the grain size dispersion preventing layer (oxide-added Co-based alloy crystal grain layer) 19 inserted immediately beneath the recording layer 17, and FIG. 3B is a graph showing the grain size distribution observed in the TEM image. FIG. 4A and FIG. 4B are a plan-view TEM image and a grain size distribution graph, respectively, of a comparison example of FIG. 1 without the grain size dispersion preventing layer 19.

To be more precise, in the example shown in FIG. 3A, a CCP—SiO2 layer with a thickness of 6.6 nm is formed under the above-described conditions, and provided as the grain size dispersion preventing layer 19 immediately beneath the Co₈₀Pt₂₀ recording layer 17. The average diameter (Dₐᵥₑ) of the magnetic crystal grains 17a of the recording layer 17 is 4.7 nm, and the variance (σ) of the grain size is 0.6 nm.

In contrast, in the comparison example shown in FIG. 4, the Co₈₀Pt₂₀ recording layer 17 is formed directly on the first underlayer (Ru layer) 15 without inserting the CCP—SiO2 layer that serves as the grain size dispersion preventing layer 19. The average diameter (Dₐᵥₑ) of the magnetic crystal grains 17a of the recording layer 17 is 7.6 nm, and the variance (σ) of the grain size is 2.1 nm.

It is understood from the observation results that the grain size dispersion preventing layer 19 inserted between the recording layer 17 and the first underlayer 15 can greatly reduce the average grain size and the variance of the magnetic crystal grains 17a of the recording layer 17. Although in the embodiment, a CCP—SiO2 layer is used as the grain size dispersion preventing layer (i.e., the oxide-added Co-based alloy crystal grain layer) 19, other suitable materials can be used as long as Co-based alloy crystal grains are spatially isolated from one another by an arbitrary oxide.

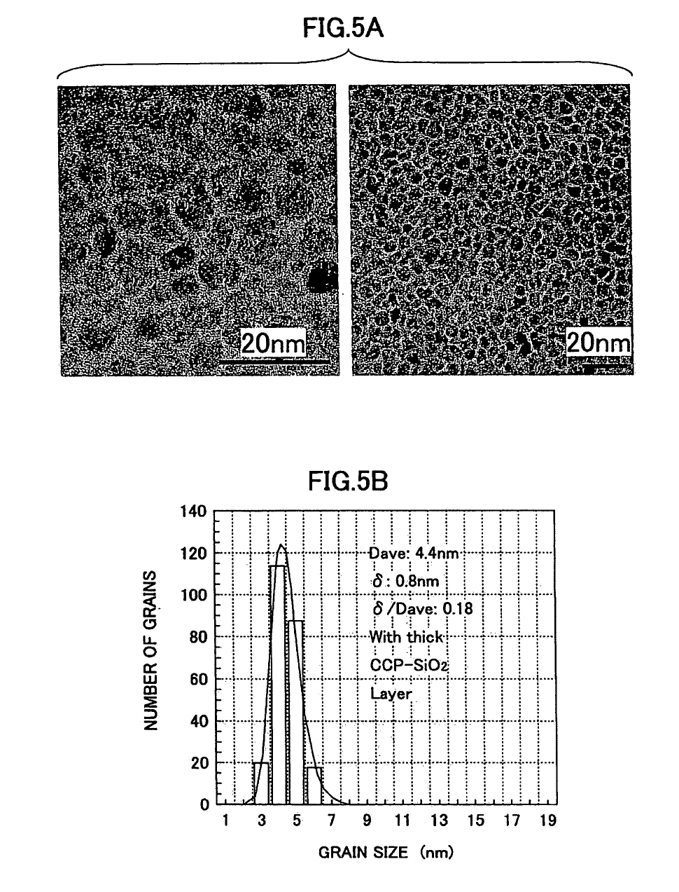

FIG. 5A shows plan-view TEM images of the CCP—SiO2 layer 19 with a thickness increased up to 13 nm, while the other structures are the same as those shown in FIG. 3, presented at different scales. In this case, the average diameter (Dₐᵥₑ) of the magnetic crystal grains 17a is reduced to 4.4 nm, and the miniaturization effect is achieved. However, the variance (σ) of the grain size is slightly increased, compared with the 6.6 nanometer-thick CCP—SiO2 shown in FIG. 3, as illustrated in the graph of FIG. 5B. This means that increasing the thickness of the grain size dispersion preventing layer (oxide-added Co-based alloy crystal grain layer) 19 is effective to reduce the average grain size, but that there is a limit to decreasing the variance in grain size. Accordingly, it is desired that the film thickness of the grain size dispersion preventing layer 19 be 5 nm to 12 nm.

By applying the structure of the embodiment to a perpendicular magnetic recording medium, the average grain size and the variance in the grain size can be reduced, and the recording density can be improved.

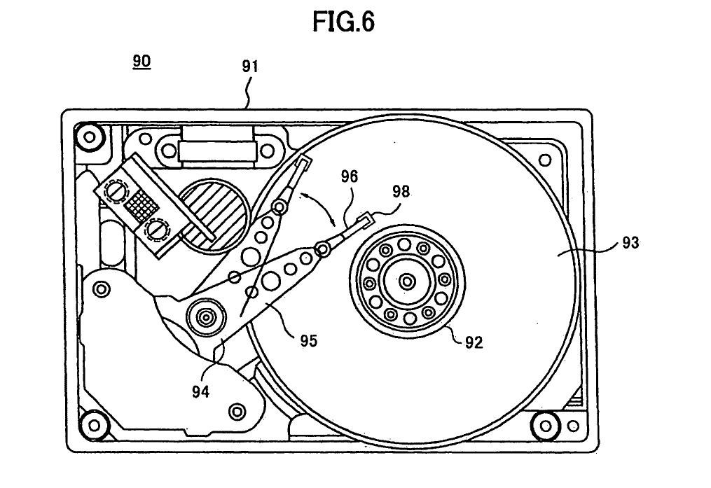

The perpendicular magnetic recording medium 10 shown in FIG. 2 can be applied to a magnetic storage apparatus such as hard disk drive. FIG. 6 is a plan view showing the major part of a magnetic storage apparatus 90. The magnetic storage apparatus 90 includes a hub 92 driven by a spindle (not graphically illustrated); a perpendicular magnetic recording medium 93 rotatably fixed to the hub 92; an actuator unit 94; an arm 95 and a suspension 96 attached to the actuator unit 94 so as to be movable in the radial directions of the perpendicular magnetic recording medium 93; and a magnetic head 58 supported by the suspension 96, all of which are provided in the housing 91. The magnetic recording medium 93 includes one or more perpendicular magnetic recording media 10 described above, which are arranged in, for example, a stack. A magnetic head 98 is provided for each of the perpendicular magnetic recording media 10. The magnetic head 98 is at least a part of the magnetic recording and reproducing means. The magnetic storage apparatus 90 is a high-performance storage as a whole because the recording density is increased, while the in-plane variation is reduced, in each of the perpendicular magnetic recording media 10.

The present application is based on Japanese Priority Patent Application No. 2007-045546, filed Feb. 26, 2007, the entire contents of which are hereby incorporated by reference.

What is claimed is:

1. A perpendicular magnetic recording medium, comprising:
a substrate;
a first underlayer formed over the substrate and formed of ruthenium or a ruthenium alloy with crystal grains growing approximately perpendicular to the substrate and isolated from one another in an in-plane direction by a first air gap;
a recording layer placed over the first underlayer and formed of magnetic crystal grains growing approximately perpendicular to the substrate and isolated from one another in the in-plane direction by a second air gap; and
a grain size dispersion preventing layer inserted between the recording layer and the first underlayer, the grain size dispersion preventing layer including crystal grains of a cobalt-based alloy growing approximately perpendicular to the substrate and an oxide isolating the crystal grains of the cobalt-based alloy from one another in the in-plane direction.

2. The perpendicular magnetic recording medium of claim 1, further comprising:
a second underlayer positioned directly beneath the first underlayer and formed as a continuous polycrystalline layer of ruthenium or ruthenium alloy.

3. The perpendicular magnetic recording medium of claim 1, further comprising:
an orientation control layer formed over the substrate and beneath the first underlayer.

4. The perpendicular magnetic recording medium of claim 2, further comprising:
an orientation control layer formed over the substrate and beneath the second underlayer.

5. The perpendicular magnetic recording medium of claim 1, wherein the variance in grain size of the magnetic crystal grains of the recording layer is at or below 0.6 nm.

6. The perpendicular magnetic recording medium of claim 1, wherein the thickness of the grain size dispersion preventing layer is in a range from 5 nm to 12 nm.

7. The perpendicular magnetic recording medium of claim 3 or 4, wherein the thickness of the orientation control layer is 2.0 nm to 10 nm, and formed of at least one selected from the group consisting of Ta, Ti, C, Mo, W, Re, Os, Hf, Mg, Pt, and an alloy thereof.

8. The perpendicular magnetic recording medium of claim 1, wherein the magnetic crystal grains of the recording layer are in alignment with the crystal grains of the cobalt-based alloy of the grain size dispersion preventing layer.

9. A magnetic storage apparatus comprising:
the perpendicular magnetic recording medium recited in claim 1; and
a magnetic head configured to write and/or read information in and/or from the perpendicular magnetic recording medium.

10. A method of fabricating a perpendicular magnetic recording medium, comprising:
forming a first underlayer of ruthenium or ruthenium alloy with crystal grains isolated from one another by a first air gap;
forming a grain size dispersion preventing layer over the first underlayer, the grain size dispersion preventing layer including crystal grains of a cobalt-based alloy spatially isolated from one another by an oxide; and
forming a recording layer directly on the grain size dispersion preventing layer, the recording layer including magnetic crystal grains isolated from one another by a second air gap.

11. The method of claim 10, further comprising:
forming a continuous polycrystalline layer of ruthenium or a ruthenium-alloy, as a second underlayer, over the substrate prior to the formation of the first underlayer.

12. The method of claim 10 or 11, wherein the grain size dispersion preventing layer has a film thickness of 5 nm to 12 nm.

13. The method of claim 10, wherein the grain size dispersion preventing layer is formed at an argon gas pressure at or above 20 millitorr and a deposition rate at or below 2 nm/s.

14. The method of claim 10, wherein the recording layer is formed by growing a CoPt layer at a deposition rate at or below 0.3 nm/s.

15. The method of claim 11, wherein the second underlayer is formed by sputtering at an argon gas pressure at or below 10 millitorr.

16. The method of claim 11, wherein the second underlayer is formed at a deposition rate at or above 0.5 nm/s.

17. The method of claim 10, further comprising:
forming a soft magnetic underlayer prior to the formation of the first underlayer;
wherein the first underlayer, the grain size dispersion preventing layer, and the recording layer are formed at a room temperature.
